(19) United States
(12) Patent Application Publication
(10) Pub. No.: US 2008/0240419 A1
(43) Pub. Date: Oct. 2, 2008

(54) APPARATUS, SYSTEM, AND METHOD FOR TESTING DATA COMPRESSION AND DATA ENCRYPTION CIRCUITRY

(76) Inventors: Melanie Jean Sandberg, Tucson, AZ (US); Scott Jeffrey Schaffer, Tucson, AZ (US)

Correspondence Address: Kunzler & McKenzie, 8 EAST BROADWAY, SUITE 600, SALT LAKE CITY, UT, 84111, US

(21) Appl. No.: 11/694,842

(22) Filed: Mar. 30, 2007

(51) Int. Cl. G06F 11/263; H04K 1/00

(52) U.S. Cl. 380/2

(57) ABSTRACT

An apparatus, system, and method are disclosed for testing data compression and data encryption circuitry. A pattern configuration module generates initial pattern parameters. Holding registers store the initial pattern parameters. A pattern generation module generates patterns for compression/encryption logic. A detection module detects a failure of the compression/encryption logic. The failure of the compression/encryption logic may be a cyclic redundancy check failure of a decompression module and/or a message authentication code failure of a decryption module.

### BACKGROUND OF THE INVENTION

1. Field of the Invention

This invention relates to testing circuits and more particularly relates to testing data compression and data encryption circuitry.

2. Description of the Related Art

Data compression and data encryption functions are often integrated within semiconductor devices. For example, an application specific integrated circuit (ASIC) configured to write data through a head to a magnetic tape and to read data from the magnetic tape may include compression, encryption, decryption, and decompression circuits.

The circuits may execute compression, encryption, decryption, and decompression algorithms at very high speeds using semiconductor elements. Each algorithm may be configured as a pipeline of semiconductor elements that perform each step of the algorithm.

A system such as a tape drive may use the data compression and data encryption circuits to compress and encode data stored to magnetic tapes. For example, a snapshot instance of a storage subsystem may be compressed and encrypted by a first tape drive to one or more backup tapes. The same and/or another tape drive may employ the decryption and decompression circuits to decrypt and decompress the data so that the data may be used. For example, the backup data may be read from the backup tapes, decrypted, and decompressed by a second tape drive.

Unfortunately, if an element of the compression, encryption, decryption, and decompression circuits is damaged, a tape drive may be unable to properly write and read compressed, encrypted data to and from a magnetic tape. For example, if an alpha particle damaged an encryption circuit element, the encryption circuit may erroneously encrypt the data stored to a backup tape. As a result, the data may be unrecoverable when needed.

### SUMMARY OF THE INVENTION

From the foregoing discussion, there is a need for an apparatus, system, and method that test data compression and data encryption circuitry. Beneficially, such an apparatus, system, and method would test proper functioning of data compression and data encryption circuitry of a tape drive.

The present invention has been developed in response to the present state of the art, and in particular, in response to the problems and needs in the art that have not yet been fully solved by currently available test methods. Accordingly, the present invention has been developed to provide an apparatus, system, and method for testing data compression and data encryption circuitry that overcome many or all of the above-discussed shortcomings in the art.

The apparatus to test data compression and data encryption circuitry is provided with a plurality of modules configured to functionally execute the steps of generating initial pattern parameters, storing the initial pattern parameters, generating patterns for compression/encryption logic, and detecting a failure of the compression/encryption logic. These modules in the described embodiments include a pattern configuration module, a pattern generation module, holding registers, and a detection module.

The pattern configuration module generates initial pattern parameters. The holding registers store the initial pattern parameters.

The pattern generation module generates patterns for compression/encryption logic from the initial pattern parameters and a random input seed. The patterns test compression and encryption algorithms. The detection module detects a failure of the compression/encryption logic.

A system of the present invention is also presented to test data compression and data encryption circuitry. The system may be embodied in an ASIC's data compression and data encryption circuitry. In particular, the system, in one embodiment, includes compression/encryption logic, a pattern configuration module, a pattern generation module, holding registers, and a detection module. The compression/encryption logic includes a compression module, an encryption module, a decryption module, and a decompression module. In an embodiment, the compression module, the encryption module, the decryption module, the decompression module, the pattern configuration module, the pattern generation module, the holding registers, and the detection module are integrated within a semiconductor device.

The compression module compresses data. The encryption module encrypts the data. The decryption module decrypts the data. The decompression module decompresses the data.

The pattern configuration module generates initial pattern parameters. The holding registers store the initial pattern parameters.

The pattern generation module generates patterns for compression/encryption logic from the initial pattern parameters and a random input seed. In particular, the patterns test compression and encryption algorithms. The pattern generator module may comprise a linear feedback shift register configured to generate a pseudo-random pattern.

The detection module detects a failure of the compression/encryption logic. In one embodiment, the detection module detects a cyclic redundancy check failure of a decompression module and/or a message authentication code failure of a decryption module.

A method of the present invention is also presented for testing data compression and data encryption circuitry. The method in the disclosed embodiments substantially includes the steps to carry out the functions presented above with respect to the operation of the described apparatus and system. In one embodiment, the method includes generating initial pattern parameters, storing the initial pattern parameters, generating patterns, and detecting a failure.

A pattern configuration module generates initial pattern parameters. The initial pattern parameters may comprise a random seed, a number of records to run before generating new initial pattern parameters, a length of the records, an initial vector for encryption, and key values for encryption. The initial pattern parameters may further comprise access point offsets for a compression macro.

Holding registers store the initial pattern parameters. A pattern generation module generates patterns for compression/encryption logic from the initial pattern parameters and a random input seed, wherein the patterns test compression and encryption algorithms. The patterns may be selected from patterns to stress a compression/non-compression boundary, patterns to vary a compression level, patterns of data segments, and patterns to test boundary conditions in a compression history buffer.

A detection module detects a failure of the compression/encryption logic. The failure of the compression/encryption logic may be a cyclic redundancy check failure of a decompression module and/or a message authentication code failure of a decryption module.

References throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention provides an apparatus, a system, and a method for efficiently testing data compression and data encryption circuitry. Beneficially, such an apparatus, a system, and a method efficiently test data compression and data encryption circuitry in the field. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a tape drive comprising data compression and data encryption circuitry in accordance with the present invention;

FIG. 2 is a schematic block diagram illustrating one embodiment of an apparatus for testing data compression and data encryption circuitry of the present invention;

FIG. 3 is a schematic flow chart illustrating one embodiment of a method for testing data compression and data encryption circuitry of the present invention; and

FIG. 4 is a schematic flow chart illustrating one embodiment of a particular method for testing failure of data compression and data encryption circuitry of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays (FPGA), programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within the modules, and may be embodied in any suitable form and organized within any suitable type of data structure. The operational data may be collected as a single data set, or may be distributed over different locations including different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

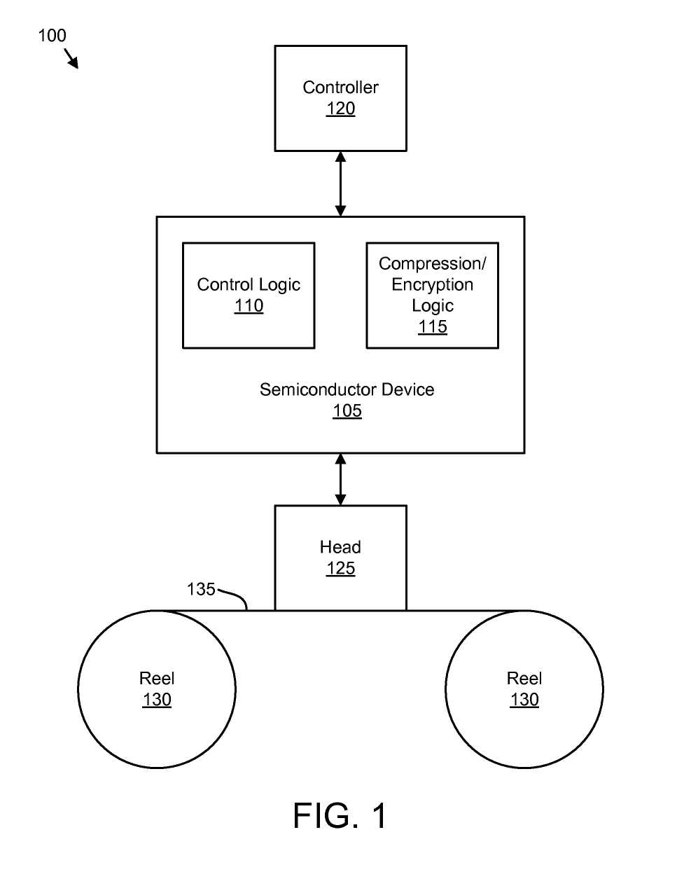

FIG. 1 is a schematic block diagram illustrating one embodiment of a tape drive 100 comprising data compression and data encryption circuitry in accordance with the present invention. The tape drive 100 includes a semiconductor device 105, a controller 120, a head 125, a tape 135, and reels 130. The semiconductor device 105 includes control logic 110 and compression/encryption logic 115. The head 125 may be a read-write head as is well known to those of skill in the art. Although in FIG. 1, one controller 120, one semiconductor device 105, one head 125, one tape 135, and two reels 130 are shown, any number of those may be used in the tape drive 100.

The tape drive 100 writes data to the magnetic tape 135. The magnetic tape 135 may move in both forward and backward directions across the head 125. The magnetic tape 135 may store encoded data as is known to those skilled in the art.

The reels 130 may spool the proximal and distal ends of the magnetic tape 135 so that the magnetic tape 135 is in close proximity of the head 125. Any one of the reels 130 may act as a leading reel. The magnetic tape 135 may wind on the leading reel and unwind on a trailing reel. The head 125 may read data from and/or write data to the tape 135. The head 125 may be of the Metal in Gap (MIG) type, Thin Film (TF) type, or the like.

The control logic circuit 110 of the semiconductor device 105 may serve as a control sequencer between the compression/encryption logic 115 and the controller 120. The control logic 110 may be fabricated of integrated logic circuits or the like. The control logic 110 may use a Self-Timed Approach (STA) or Clocked Approach (CA) timing or the like to communicate with the controller 120, the head 125, and the compression/encryption logic 115.

The compression/encryption logic 115 of the semiconductor device 105 may include integrated logic circuits as is known to those skilled in the art. The compression/encryption logic 115 may compress and encrypt the data and/or decompress and decrypt the backup data. The compression/encryption logic 115 may execute compression, encryption, decryption, and decompression algorithms using semiconductor elements at very high speeds. Each algorithm may be configured as a pipeline of semiconductor elements that perform each step of the algorithm.

The compression/encryption logic 115 may compress and encrypt the data written to the magnetic tape 135 to create a backup tape. For example, receiving a signal from the control logic 110 to compress and encrypt the data, the compression/encryption logic 115 may compress and encrypt the data from the controller 120 to create a backup copy on the magnetic tape 135 by executing the compression, encryption algorithm. Alternatively, the compression/encryption logic 115 may decompress and decrypt the backup data from the backup magnetic tape 135. For example, receiving a signal from the control logic 110 to decompress and decrypt the encoded data from the magnetic tape 135, the compression/encryption logic 115 may decompress and decrypt the backup data from the backup magnetic tape 135 by executing the decompression, decryption algorithm.

The controller 120 may communicate with the semiconductor device 105 to encrypt and compress the data or to decompress and decrypt the backup data. The semiconductor device 105 may communicate with the magnetic tape 135 through head 125 to read the encoded data and/or write the encoded data.

The tape drive 100 may use the compression/encryption logic 115 to compress and encrypt the data written to the magnetic tape 135 to create the backup tape. For example, receiving a signal from the controller 120 through the control logic 110, the head 125 may read the data from the magnetic tape 135 and the compression/encryption logic 115 may compress and encrypt the read data.

Alternatively, the tape drive 100 may use the compression/encryption logic 115 to decompress and decrypt the backup data from the magnetic tape 135. For example, receiving a signal from the controller 120 through the control logic 110, the read-write head 125 may read the backup data from the magnetic tape 135 and the compression/encryption logic 115 may decompress and decrypt the read backup data. All communication between elements may be through semiconductor traces, semiconductor gates, vias, circuit card traces, and the like.

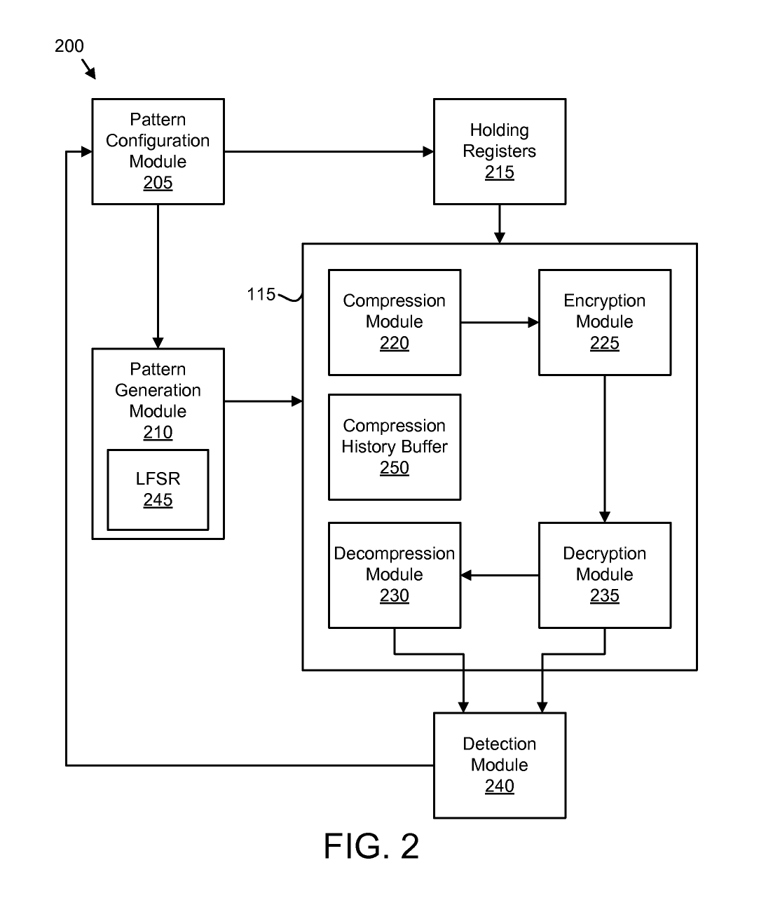

FIG. 2 is a schematic block diagram illustrating one embodiment of an apparatus 200 for testing data compression and data encryption circuitry of the present invention. The apparatus 200 efficiently tests data compression and data encryption circuitry of the tape drive 100 of FIG. 1. The description of the apparatus 200 refers to elements of FIG. 1, like numbers referring to like elements. The apparatus 200 includes a pattern configuration module 205, a pattern generation module 210, compression/encryption logic 115, a detection module 240 and holding registers 215. The compression/encryption logic 115 may include a compression module 220, an encryption module 225, a decryption module 235, a decompression module 230, and a compression history buffer 250.

In an embodiment of the present invention, the compression/encryption logic 115, the pattern configuration module 205, the pattern generation module 210, the holding registers 215, and the detection module 240 are integrated on a semiconductor device 105. For example, the compression/encryption logic 115, the pattern configuration module 205, the pattern generation module 210, the holding registers 215, and the detection module 240 may be embodied in the semiconductor device 105 of the tape drive 100.

The pattern configuration module 205 generates initial pattern parameters. The initial pattern parameters may comprise a random seed. The random seed may be number. For example, the pattern configuration module 205 may generate a random seed with the value of two hundred and forty-eight (248) as initial pattern parameter.

The initial pattern parameters may also comprise a number of records to run before generating new initial pattern parameters. For example, the pattern configuration module 205 may specify to run ten thousand (10000) records before generating new initial pattern parameters.

The initial pattern parameters may also comprise a length of the records. For example, the pattern configuration module 205 may specify that each record be of two hundred and fifty-six (256) bytes in length.

The initial pattern parameters may also comprise an initial vector for encryption. The initial vector may be a specified pattern of the specified length.

The initial pattern parameters may also comprise key values for encryption. For example, the pattern configuration module 205 may generate the key values for encryption. The key values may control the operation of cryptography algorithm. For example, the key values may be a one hundred and twenty-eight (128) bit and/or a two hundred and fifty-six (256) bit binary number and may control the particular transformation of plaintext into ciphertext, or vice versa during decryption.

The initial pattern parameters may further comprise access point offsets for a compression macro. For example, the pattern configuration module 205 may generate the access point offsets for the compression macro. The access point offsets may be sequences of pseudo-random numbers for the compression macro.

The holding registers 215 may be a data register, specified words in a data array, or the like. The holding registers 215 may be implemented as a register file in the apparatus 200. The holding registers 215 store the initial pattern parameters. For example, the holding registers 215 may store the random seed, the number of records, the length of records, and/or the initial vector. The apparatus 200 may comprise two (2) or more holding registers 215.

The pattern generation module 210 generates patterns for compression/encryption logic 115 from the initial pattern parameters and a random input seed. The patterns test compression and encryption algorithms. The patterns may be selected from patterns to stress a compression/non-compression boundary, patterns to vary a compression level, patterns of data segments, and patterns to test boundary conditions in a compression history buffer 250. The compression/encryption logic 115 compresses, encrypts, decrypts, and decompresses the patterns.

The pattern generation module 210 may include a linear feedback shift register (LFSR) 245. The LFSR 245 may be a plurality of shift registers in a circular configuration. A seed value may be shifted a specified number of times to generate a psuedo-random output from one or more register outputs.

The random input seed may be generated by the pattern configuration module 205. The random input seed may be the initial value of the LFSR 245. The LFSR 245 may generate the data in a sequence of pseudo-random numbers. Since the operation of the LFSR 245 may be of deterministic in nature, the sequence of numbers produced by the LFSR 245 may be completely determined by its current or previous state. Also since the LFSR 245 may have a finite number of possible states, the LFSR 245 may enter a repeating cycle. The LFSR 245 may use a pseudo-random algorithm that may generate the sequence of numbers. The pseudo-random algorithms may include Blum Blum Shub, Fortuna, and Mersenne Twister. The pattern generation module 210 may generate the sequence of pseudo-random numbers into patterns of the type as listed above.

For example, the pattern generation module 210 may generate a sequence of pseudo-random numbers into a pattern to stress a compression/non-compression boundary. The pattern to stress a compression/non-compression boundary may generate data based upon a Gaussian curve that dictates the frequency of string matches and the length of string matches. The generation of pattern to stress a compression/non-compression boundary may depend upon the initial pattern parameters. The initial pattern parameters may be set to stress compression history buffer boundary conditions.

There may be different history buffer boundary conditions. There may be a boundary window where it may be optimal to switch from a compression mode to a non-compression mode, or back again. The history buffer is a rotating content addressable memory (CAM). When a data word is supplied to the CAM, the CAM returns one or more addresses where the CAM is stored. There is a boundary at the place where the address rotates from the end of the CAM back to the start of the CAM.

Tweaking of the initial pattern parameters may cause the pattern generation module 210 to generate a different type of patterns for compression/encryption logic 115. For example, the pattern generation module 210 may generate the sequence of pseudo-random numbers into a pattern to test boundary conditions. The pattern to test boundary conditions in a compression buffer may generate data based on an algorithm to create a scheme swap from compression to raw mode output and back to compression mode. The frequency of the scheme swapping may depend upon the initial pattern parameters.

In another example, the pattern generation module 210 may convert the sequence of pseudo-random numbers into a pattern of data segments. One segment may be of some fixed pattern, followed by a segment of random data, followed by a different fixed pattern. The segments lengths and patterns may be controlled through the initial pattern parameters.

The compression/encryption logic 115 may compress, encrypt, decrypt, and decompress the patterns. For example, the compression/encryption logic 115 may compress, encrypt, decrypt, and decompress the patterns using compression, encryption, decryption, and decompression algorithm.

The compression module 220 compresses the data. The data may be in the form of patterns generated by the pattern generation module 210. For example, the compression module 220 may initiate the process of encoding the data/pattern using fewer bits than an uncoded representation would use by using specific lossless encoding schemes.

The encryption module 225 encrypts the data. The data may be in the form of patterns generated by the pattern generation module 210. For example, the encryption module 225 may encrypt the data/patterns using the key values for encryption. The encryption module 225 may use a cryptography algorithm for encryption of the data/patterns.

The decompression module 230 decompresses the data. The data may be in the form of patterns generated by the pattern generation module 210. For example, the decompression module 230 may initiate the process of decoding the data/pattern to the original format by using specific decoding schemes.

The decryption module 235 decrypts the data. The data may be in the form of patterns generated by the pattern generation module 210. For example, the decryption module 235 may decrypt the data/patterns using the key values for decryption. The decryption module 235 may use a decryptography algorithm for decryption of the data/patterns.

The detection module 240 detects a failure of the compression/encryption logic 115. The detection module 240 may detect a cyclic redundancy check (CRC) failure of the decompression module 230. The CRC may be a type of hash function that produces a checksum. The hash function may be selected from Gost-Host, HAS-160, HAVAL, Modification Detection Code 2 (MDC-2), Message Digest Algorithm 2 (MD2), Message Digest Algorithm 4 (MD4), Message Digest Algorithm 5 (MD5), N-Hash, RACE Integrity Primitives Evaluation Message Digest (RIPEMD), Secure Hash Algorithm (SHA) family, WHIRLPOOL, and the like. The checksum may be a small, fixed number of bits for a block of decompressed data/pattern generated by the decompression module 230.

Alternatively, the detection module 240 detects a message authentication code (MAC) failure of the decryption module 235. For example, while decrypting the data/pattern the MAC algorithm may accept a secret key and an arbitrary length of the data/pattern to be authenticated. The MAC algorithms may be selected from Galois/Counter Mode (GCM), Cipher Block Chaining Message Authentication Code (CBC-MAC), keyed-hash message authentication code (HMAC), One-key Message Authentication Code (OMAC), Parallelizable Message Authentication Code (PMAC), Universal Message Authentication Code (UMAC), Poly 1305-AES, Very Efficient Substitution Transposition (VEST) ciphers, and the like. The detection module 240 may detect the MAC failure of a decryption module 235 if the secret key and the arbitrary length of the data/pattern is not authenticated.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and the symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

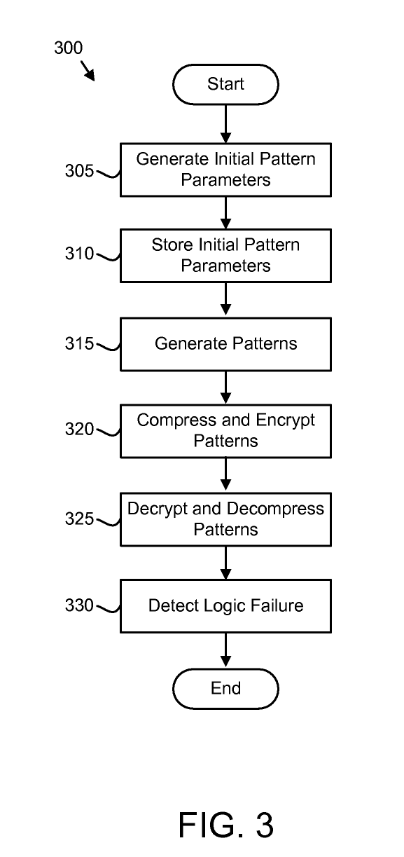

FIG. 3 is a schematic flow chart diagram illustrating one embodiment of a data compression and data encryption circuitry testing method 300 of the present invention. The method 300 substantially includes the steps to carry out the functions presented above with respect to the operation of the described apparatus 200 and system 100 of FIGS. 2 and 1 respectively. The description of method 300 refers to elements of FIGS. 1-2, like numbers referring to the like elements.

The method 300 starts and in an embodiment, the pattern configuration module 205 generates 305 initial pattern parameters. In an embodiment, the initial pattern parameters comprise a random seed, a number of records to run before generating new initial pattern parameters, a length of the records, an initial vector for encryption, and key values for encryption.

In an embodiment, the pattern configuration module 205 generates 305 the random seed as the initial pattern parameter. For example, the pattern configuration module 205 may generate 305 the random seed with the value of four hundred and ninety six (496) as the initial pattern parameter.

In additional, the pattern configuration module 205 may specify the number of records to run before generating new initial pattern parameters. For example, the pattern configuration module 205 may specify two thousand (2000) records to run before generating new initial pattern parameters.

In an embodiment, the pattern configuration module 205 specifies the length of the records as the initial pattern parameter. For example, the pattern configuration module 205 may specify that each record be of five hundred and twelve (512) bits in length.

In additional, the pattern configuration module 205 may generate 305 the initial vector for encryption as the initial pattern parameter. For example, the pattern configuration module 205 may generate 305 the initial vector of the specified pattern of the type ‘xxx512xyz’ and of the specified length of thirty-two (32) bits. The specified pattern of the type ‘xxx512xyz’ and of the specified length of thirty-two (32) bits may propagate itself to express itself as a pattern.

In one embodiment, the pattern configuration module 205 generates 305 the key values for encryption as the initial pattern parameter. For example, the pattern configuration module 205 may generate the key values such as a hexadecimal value ‘ab12cd34ef56x’ for encryption operations.

The pattern configuration module 205 may further generate 305 access point offsets for a compression macro as initial pattern parameters. For example, the pattern configuration module 205 may further generate 305 sequences of pseudo-random numbers as access point offsets for the compression macro. The compression macro may be in the form of the patterns listed above.

The initial pattern parameters may be set to stress history buffer boundary conditions. For example, the initial vector of the specified pattern of the type ‘xxx512xyz’ and of the specified length of thirty-two (32) bits may be set to stress history buffer boundary conditions.

The holding registers 215 store 310 the initial pattern parameters. For example, the holding registers 215 may store 310 the key values such as ‘ab12cd34ef56x’ in Dynamic Random Access Memory (DRAM) registers as is known to those skilled in the art. Alternatively, for example, the holding registers 215 may store 310 that two thousand (2000) records to run before generating new initial pattern parameters.

The pattern generation module 210 generates 315 patterns for compression/encryption logic 115 from the initial pattern parameters and the random input seed. The random input seed generated by the pattern configuration module 205 may be an initial value of the LFSR 245. The LFSR 245 may generate the data in a sequence of pseudo-random numbers. The pattern generation module 210 may generate 315 the sequence of pseudo-random numbers into a pattern to stress a compression/non-compression boundary depending upon the initial pattern parameters. For example, the pattern generation module 210 may generate 315 the pattern to stress a compression/non-compression boundary. The pattern to stress a compression/non-compression boundary may generate data based upon a Gaussian curve that dictates the frequency of string matches and length of string matches.

Alternatively, the pattern generation module 210 generates 315 the sequence of pseudo-random numbers into a pattern to test boundary conditions. For example, the pattern generation module 210 may generate 315 a pattern series that repeatedly crosses boundary conditions.

In an embodiment, the pattern generation module 210 converts the sequence of pseudo-random numbers into a pattern of data segments. For example, the pattern generation module 210 may convert each record be of five hundred and twelve (512) bits in length into a pattern of data segments.

In another example, the pattern to test boundary conditions in a compression buffer may generate data based on an algorithm to create a scheme swap from compression to raw mode output and back to compression mode depending upon the initial pattern parameters.

The compression module 220 and encryption module 225 of the compression/encryption logic 115 compresses and encrypts 320 the pattern. For example, the compression module 220 may compress and encrypt 320 the pattern of data segments into a pattern of fewer bits than an uncoded representation of the pattern using the key values such as the hexadecimal value ‘ab12cd34ef56x’.

The compression module 220 may switch from a compression mode to a non-compression mode, or back again depending upon history buffer boundary conditions. The history buffer may be a rotating content addressable memory (CAM). For example, when the pattern is supplied to the CAM, the CAM may return one or more addresses where the CAM is stored. There may be a boundary at the place where the address rotates from the end of the CAM back to the start of the CAM.

The decompression module 230 and the decryption module 235 may decompress and decrypt 325 the pattern of the data. For example, the decompression module 230 and the decryption module 235 may decompress and decrypt 325 the encoded pattern of data segments from a pattern of fewer bits to than an uncoded representation of the pattern using the initial vector of the specified pattern of the type ‘xxx512xyz’ and of the specified length of thirty-two (32) bits.

The detection module 240 detects 330 a failure of the compression/encryption logic 115 and the method 300 terminates. In an embodiment, the detection module 240 may detect 330 a failure of the decompression module 230. For example, the detection module 240 may detect 330 the cyclic redundancy check (CRC) failure of the decompression module 230 as will be described hereafter.

Alternatively, the detection module 240 detects 330 a failure of the decryption module 235. For example, the detection module 240 may detect 330 a MAC failure of the decryption module 235 as will be described hereafter.

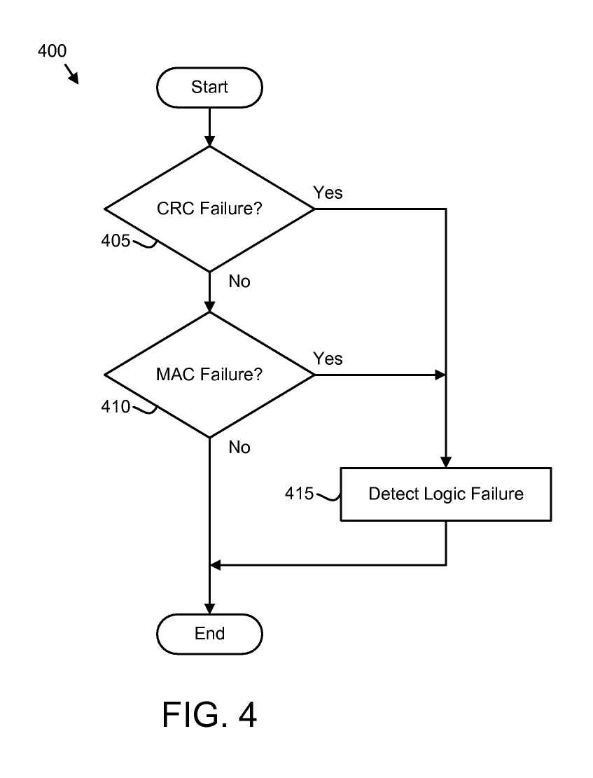

FIG. 4 is a schematic flow chart diagram illustrating one embodiment of a method 400 for detecting a failure of the compression/encryption logic 115 of the present invention. The method 400 substantially includes the steps to carry out the functions presented above with respect to the operation of the described apparatus 200, system 100, and method 300 of FIGS. 2, 1, and 3 respectively. In particular, the method 400 may be embodied in step 330 of FIG. 3. The description of method 400 refers to elements of FIGS. 1-3 like numbers referring to the like elements.

The method 400 starts and in an embodiment, the detection module 240 detects 405 a CRC failure. For example, the detection module 240 may detect 405 that there is a CRC failure when the decompression module 230 asserts a CRC failure signal. The decompression module 230 may detect the CRC failure from an erroneous checksum as is well known to those skilled in the art.

If the detection module 240 detects 405 that the CRC is a failure, the detection module 240 detects 415 a compression/encryption logic 115 failure and the method 400 terminates. For example, if a hash function of CRC of the decompression module 230 fails, the detection module 240 may detect 415 a compression/encryption logic 115 failure.

In one embodiment, if the detection module 240 does not detect 405 a CRC failure, the detection module 240 detects 410 if there is a MAC failure. For example, the detection module 240 may detect the MAC failure when the decryption module 235 asserts a MAC failure signal. The decryption module 235 may detect the MAC failure using a key value as is well known to those of skill in the art.

If the detection module 240 detects 410 the MAC failure, the detection module 240 detects 415 a compression/encryption logic 115 failure and the method 400 terminates. For example, if a MAC algorithm of the MAC does not accept a secret key and an arbitrary length of the data/pattern to be authenticated of the decryption module 235, the detection module 240 may detect 415 the compression/encryption logic 115 failure.

Therefore the data compression and data encryption circuitry testing method 300 and method 400 for detecting a failure of the compression/encryption logic 115 tests data compression and data encryption circuitry of the tape drive 100. The methods 300, 400 beneficially would efficiently test data compression and data encryption circuitry in the field.

The present invention provides an apparatus, a system, and a method for efficiently testing data compression and data encryption circuitry. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to test data compression and data encryption circuitry, the apparatus comprising:
a pattern configuration module configured to generate initial pattern parameters;
a pattern generation module configured to generate patterns for compression/encryption logic from the initial pattern parameters and a random input seed, wherein the patterns test compression and encryption algorithms; and
holding registers configured to store the initial pattern parameters;
a detection module configured to detect a failure of the compression/encryption logic.

2. The apparatus of claim 1, wherein the patterns are selected from patterns to stress a compression/non-compression boundary, patterns to vary a compression level, patterns of data segments, and patterns to test boundary conditions in a compression history buffer.

3. The apparatus of claim 1, wherein the initial pattern parameters comprise a random seed, a number of records to run before generating new initial pattern parameters, a length of the records, an initial vector for encryption, and key values for encryption.

4. The apparatus of claim 3, the initial pattern parameters further comprising access point offsets for a compression macro.

5. The apparatus of claim 1, wherein the detection module detects a failure selected from a cyclic redundancy check failure of a decompression module and a message authentication code failure of a decryption module.

6. The apparatus of claim 1, wherein the pattern generator module comprises a linear feedback shift register configured to generate a pseudo-random pattern.

7. The apparatus of claim 1, the compression/encryption logic is configured to compress, encrypt, decrypt, and decompress the patterns.

8. The apparatus of claim 1, wherein the compression/encryption logic, the pattern configuration module, the pattern generation module, the holding registers, and the detection module are integrated on a semiconductor device.

9. A method for testing data compression and data encryption circuitry, the method comprising:
generating initial pattern parameters;
generating patterns for compression/encryption logic from the initial pattern parameters and a random input seed, wherein the patterns test compression and encryption algorithms; and
storing the initial pattern parameters;
detecting a failure of the compression/encryption logic.

10. The method of claim 9, wherein the patterns are selected from patterns to stress a compression/non-compression boundary, patterns to vary a compression level, patterns of data segments, and patterns to test boundary conditions in a compression history buffer.

11. The method of claim 9, wherein the initial pattern parameters comprise a random seed, a number of records to run before generating new initial pattern parameters, a length of the records, an initial vector for encryption, and key values for H encryption.

12. The method of claim 11, the initial pattern parameters further comprising access point offsets for a compression macro.

13. The method of claim 9, wherein the failure is selected from a cyclic redundancy check failure of a decompression module and a message authentication code failure of a decryption module.

14. The method of claim 9, wherein the patterns are generated using a linear feedback shift register that creates a pseudo-random pattern.

15. A system to test data compression and data encryption circuitry, the system comprising:
compression/encryption logic comprising
a compression module configured to compress data;
an encryption module configured to encrypt the data;
a decryption module configured to decrypt the data;
a decompression module configured to decompress the data;
a pattern configuration module configured to generate initial pattern parameters;
a pattern generation module configured to generate patterns for compression/encryption logic from the initial pattern parameters and a random input seed, wherein the patterns test compression and encryption algorithms; and
holding registers configured to store the initial pattern parameters;
a detection module configured to detect a failure of the compression/encryption logic, wherein the compression module, the encryption module, the decryption module, the decompression module, the pattern configuration module, the pattern generation module, the holding registers, and the detection module are integrated within a semiconductor device.

16. The system of claim 15, wherein the patterns are selected from patterns to stress a compression/non-compression boundary, patterns to vary a compression level, patterns of data segments, and patterns to test boundary conditions in a compression history buffer.

17. The system of claim 15, wherein the initial pattern parameters comprise a random seed, a number of records to run before generating new initial pattern parameters, a length of the records, an initial vector for encryption, and key values for encryption.

18. The system of claim 17, the initial pattern parameters further comprising access point offsets for a compression macro.

19. The system of claim 15, wherein the detection module detects a failure selected from a cyclic redundancy check failure of a decompression module and a message authentication code failure of a decryption module.

20. The system of claim 15, wherein the pattern generator module comprises a linear feedback shift register configured to generate a pseudo-random pattern.
